(19) United States
(12) Patent Application Publication
(10) Pub. No.: US 2023/0092507 A1
(43) Pub. Date: Mar. 23, 2023

(54) FORWARDING MESSAGES IN DIGITAL COMMUNICATION APPLICATION WITH OR WITHOUT NOTE TO THE FORWARD MESSAGES

(71) Applicant: Sarath KAKUMANU, Chennai (IN)

(72) Inventor: Sarath KAKUMANU, Chennai (IN)

(21) Appl. No.: 17/791,915

(22) PCT Filed: Jan. 9, 2021
(86) PCT No.: PCT/IN2021/050025

§ 371 Date: Jul. 11, 2022

(30) Foreign Application Priority Data
Jan. 9, 2020 (IN) 202041001085

(51) Int. Cl. H04L 51/214; H04L 51/216

(52) U.S. Cl. CPC H04L 51/214; H04L 51/216

(57) ABSTRACT

A system, method, and a computer program product thereof, for forwarding messages (one message or more than one message) to one user or a plurality of users or a group of users or a plurality of group of users with or without the forward note is a first-of-its-kind system ever introduced in a digital messaging application. Forwarding single message or multiple messages with/without forward note is configured in association with a digital messaging application for a user to choose the method of forwarding a message to a group or multiple group or individual or multiple individual, within the network environment. To accomplish this feature, a sending device and a receiving device will be connected through the specially configured servers. Providing a sophisticated way of forwarding the message with or without forward note, the said messaging application gives the users the utmost convenience.

### CROSS-REFERENCE TO RELATED APPLICATION

The present PCT application claims priority to, and the benefit of, Indian application no. 202041001085, which was filed on Sep. 1, 2020 and is incorporated herein by reference in its entirety.

### TECHNICAL FIELD

The present invention, in general, relates to information technology and computer applications, and more particularly to a digital messaging application for mobile communication devices which can be accessed from all types of communication devices like Mobile phones, Desktop Computers, Laptop Computers, and Digital Tablets.

### BACKGROUND OF THE INVENTION

Mobile communication devices such as Mobile phones, IOS devices, Android devices, along with digital tablets, Desktop computers, Laptop computers are increasingly powerful and the sources of potential incoming/outgoing messages are increasingly more varied. As a result, such mobile communication devices are being designed and built to permit users to accept various types of messages.

Communication Applications include but not limited to WhatsApp, WeChat, Slack, Telegram, Facebook and Google Hangout are becoming increasingly popular among Internet and worldwide web users because they are easy to use and provide a simple way to instantly forward a message. But there are limitations in forwarding a message by the users. In applications like Whatsapp, the message can be forwarded only to limited users (5 no's) at a time. Further, there is no facility to write a personal or official note along with the forward message.

Modern messaging systems on communication devices like smart mobile phones, digital tablets, laptop computers, desktop computers have been increasingly bringing in a wide scope and opportunity for businesses to communicate with their target audience via campaigning offers and discount messages in the messaging systems. For example, instant mobile messaging applications are widely used for sending short messages (business-related messages/personal messages) in a single time to multiple users. But limitations are there like text characters in the conveying message, the number of users selected for receiving the promotional message.

Such conventional messaging technologies permit all parties (i.e. sender and recipient(s)) to specifically identify an originating party from which the message has been transmitted and any recipient party which has received the text message. More particularly, conventional messaging technologies permit each party interacting via messaging to obtain identification credentials for every other party interacting therewith.

Thus, there is a need for a system facilitating a method to handle the forwarding of messages/communication (single message/multiple messages) to a group/individual/(includes unknown multiple contacts/unknown group by adding a forward note, thereby addressing certain key challenges in the existing messaging application tools, such as Whatsapp, Facebook Messenger, Google Hangout, WeChat, Slack, Signal, IMO, Telegram, Hike and so on.

While forwarding some kind of ‘specific messages’ that may be very important the user may require forward note option because it might be helpful to mention about the source (original sender) or about message being forwarded or some personal note—in all these scenarios, the user would like to use the option—‘Forwarding the message with or without note.’

Based on the foregoing, a further need exists for a structured messaging application with a user-friendly messaging application paradigm for forwarding commercial/individual message through a group/individual to an individual/multiple individual/group/multiple groups with or without a note as described in greater detail herein.

### SUMMARY OF THE INVENTION

The following summary is provided to facilitate an understanding of some of the innovative features unique to the disclosed embodiment and is not intended to be a full description.

User is in need of a better way of forwarding single/multiple messages to an individual or group from an individual/group with or without a note to the forward message.

An object of the present invention is to overcome the drawbacks of the existing prior art techniques by providing a user-friendly mechanism of addressing the challenges faced by the users while forwarding the messages in an internet-based messaging application.

Another object of the present invention is to allow the users to make their choice of forwarding the message with a note/without note.

It is, therefore, one aspect of the disclosed embodiments to provide for an improved digital messaging application for forwarding the messages in mobile communication devices.

Another aspect of the disclosed embodiments to provide for an improved novel and user-friendly system and method for forwarding messages to an individual/multiple individuals.

One more aspect of the disclosed embodiments to provide for an improved novel and user-friendly system and method for forwarding messages to a group/multiple groups.

One more aspect of the disclosed embodiments to provide for an improved system and method for forwarding messages to an individual/multiple contacts/group/multiple groups/unknown contacts/unknown group with a forward note.

Another aspect of the disclosed embodiments to provide for an improved system and method for sharing messages to an individual/multiple contacts/group/multiple groups/unknown contacts/unknown group without a forward note.

Further aspect of the disclosed embodiments to provide for an improved method for sharing messages from an individual/group to an individual/multiple individuals/group/multiple groups/unknown contacts/unknown group with or without forward note. The present invention, therefore, is a new and effortless way of forwarding the messages in an internet-based messaging application. It is a new and user-friendly way of forwarding the messages with or without a forward note. The user has the option to choose individual/multiple individuals/groups/multiple groups as per his/her choice. After choosing the contacts the sender further provides the option to add a forward note regarding the forward message as per his/her choice.

The message forward module of the digital messaging application helps the user to forward the single message or multiple messages to anyone in his directory or to a group by choosing his preference of forwarding either with note or without note. Similarly, the message forward module of the structured messaging application helps the user to forward the message received/communicated in a group to any individual user or to another group by choosing his preference of forwarding either with/without a forward note. Once the user selects the message, the user can conveniently use the forward feature to forward the message either with note or without note. In forward message, if the sender prefers to send with note, the receiver can get additional information about the forward message like origin detail/personal note/regarding the message etc. The forwarded message can be an attachment (audio, video, pictures, documents etc).

The aforementioned aspects and other objectives and advantages can now be achieved as described herein. A system and method for forwarding Business/Personal messages (single message/multiple messages) from an individual/group to an individual/group with or without a Note. A message forward feature comprising forwarding the message with a note configured in association with a structured messaging application (Internet Messaging Application) for the user to forward a business message/personal message to a multiple/individual user within the network environment. A messaging server (High-End server) for receiving, processing and forwarding the message with respect to the user from the internet messaging application within the group based on his choice of forwarding preference.

The invention herein relates to a digital messaging application for business communications, individual conversations, business conversations in which forwarding the message with a note (additional information) regarding the message have a significant role. The invention additionally relates to a novel and user-friendly mechanism for forwarding the messages in a network environment. Further, the present invention specifically relates to an improved system and method for forwarding messages to an individual/group by adding a note to the forward message, forwarded between two individuals/multiple individuals/group/multiple groups.

According to an aspect, a method for forwarding at least one message from a first user (sender) to a second user (receiver) or multiple users or a group of users or multiple group of users, the method comprising: selecting, at least one message or more than one message, by the first user from a first sender device; searching and selecting, at least one second user (receiver) or multiple users or a group of users or multiple group of users, by the first user from the first sender device; forwarding, the at least one selected message or more than one message by the first user (sender) from the first-sender device, using an interface of the first sender device; wherein the interface of the first sender device comprises: providing, to the first user, an option for forwarding at least one selected message or more than one message; selecting the at least one message or more than one message, by the first user, and forwarding to a first receiver device of a selected second user (receiver) or multiple users or a group of users or multiple group of users; forwarding the message from the first sender device to the first receiver device of the selected at least one second user (receiver) or multiple users or a group of users or multiple group of users, according to the option selected by the first user (with or without note); and receiving the forward message, by the first receiver device of the selected at least one second user (receiver) or multiple users or a group of users or multiple group of users, according to the option selected by the first user, wherein the first user is an individual or a user of the group of users.

According to another aspect, a system for forwarding a message, the system comprises: a first sender device of a first user configured to send and receive the forward messages using an interface; a first receiver device of a second user configured to send and receive forward messages using an interface; a server unit communicably coupled to the first sender device and the first receiver device, the server unit being configured to receive, process and forward the messages to and from the first sender device and the first receiver device, and wherein the first user and second user are individual or a user of a group of users, wherein the first sender device is configured to: select, at least one message; search and select, at least one second user (receiver) or multiple users or a group of users or multiple group of users; forward, the at least one selected message using an interface of the first sender device wherein the interface of the first sender device comprises: selecting an option for forwarding the at least one selected message, by the first user, from the plurality of options for forwarding the at least one selected message to a first receiver device of a second user (receiver) or multiple users or a group of users or multiple group of users; and forwarding the message from the first sender device to the first receiver device of the selected at least one second user or multiple users or a group of users or multiple group of users, wherein the first receiver device is configured to: receive the forward message from the first sender device.

According to a further aspect, a computer program product comprising instructions which, when executed by at least one processor, causes the processor to carry out the instructions for: selecting, at least one message, by the first user from a first sender device; searching and selecting at least one second user or multiple users or a selected group of users or multiple group of users, by the first user from the first sender device; forwarding, at least one selected message by the first user from the first sender device, using an interface of the first sender device, wherein the interface of the first sender device comprises: providing, to the first user, a plurality of options for forwarding the at least one selected message; selecting an option for forwarding the at least one selected message, by the first user, from the plurality of options for forwarding the at least one selected message to a first receiver device of a second user (receiver) or a group of users; forwarding the message from the first sender device to the first receiver device of the selected at least one second user or multiple users or a selected group of users or multiple group of users, according to the option selected by the first user; and receiving the message, by the first receiver device of the selected at least one second user (receiver) or multiple users or a group of users or multiple group of users, according to the option selected by the first user, wherein the first user is an individual or a user of the group of users, wherein the selecting, at least one message, by the first user comprises selecting a message or a plurality of messages received by the first user from other users, in the first sender device, forwarding the message comprises adding a subject note, by the first user, with the at least one message or more than one message selected by the first user for forwarding to the selected at least one second user or multiple users or a selected group of users or multiple group of users.

According to yet another aspect, a non-transitory computer readable storage medium storing one or more programs for execution by the one or more processors of a system for forwarding a message, the one or more programs including instructions for: selecting, at least one message, by the first user from a first sender device; searching and selecting, at least one second user (receiver) or multiple users or a group of users or multiple group of users, by the first user from the first sender device; forwarding, the at least one selected message or more than one message by the first user from the first sender device, using an interface of the first sender device, wherein the interface of the first sender device comprises: providing, to the first user, an option for forwarding the at least one selected message; selecting the at least one message or more than one message, by the first user, and forwarding to a first receiver device of a second user (receiver) or multiple users or a group of users or multiple group of users; forwarding the message from the first sender device to the first receiver device of the selected at least one second user or multiple users or a selected group of users or multiple group of users, according to the option selected by the first user (with or without note); and receiving the forward message, by the first receiver device of the selected at least one second user or multiple users or a selected group of users or multiple group of users, according to the option selected by the first user, wherein the first user is an individual or a user of the group of users, wherein the selecting, at least one message, by the first user comprises selecting a message or a plurality of messages received by the first user from other users, in the first sender device, forwarding the message further comprises adding a subject note, by the first user, with the at least one message or more than one message selected by the first user forwarding to the selected at least one second user or multiple users or a selected group of users or multiple group of users.

The other aspects of the invention will be apparent from the detailed description that follows.

### BRIEF DESCRIPTION OF THE DRAWINGS

The above and other aspects features and advantages of the embodiments of the present disclosure will be more apparent in the following description taken in conjunction with the accompanying drawings.

FIG. 1 illustrates a graphical representation of the sender internet messaging folder with a three-dot icon, in this case used for forwarding single message, in accordance with the embodiments of the present invention.

FIG. 2 illustrates a graphical representation of the sender internet messaging folder with the option to select the message for forwarding single message, in accordance with the embodiments of the present invention.

FIG. 3 illustrates a graphical representation of the sender internet messaging folder with the selected single message for forwarding single message, in accordance with the embodiments of the present invention.

FIG. 4 illustrates a graphical representation of the sender internet message folder with the forward message count and the option to select the individual/multiple contacts/group/multiple groups/unknown contact/unknown group from the list of contacts and the option to forward the selected message with or without a note, in accordance with the embodiments of the present invention.

FIG. 5 illustrates a graphical representation of the sender internet message folder with the selected members of individual from the list of contacts and the option to forward the selected single message, in accordance with the embodiments of the present invention.

FIG. 6 illustrates a graphical representation of the sender internet message folder with the selected groups from the list of groups along with the selected members of individual from the list of contacts and the option to forward the selected single message, along with a note, in accordance with the embodiments of the present invention.

FIG. 7 illustrates a graphical representation of the sender internet message folder showing forward message along with a note in the individual message folder, in accordance with the embodiments of the present invention.

FIG. 8 illustrates a graphical representation of the sender internet message folder showing forward message along with a note in the group message folder, in accordance with the embodiments of the present invention.

FIG. 9 illustrates a graphical representation of the sender internet message folder with the selected groups from the list of groups along with the selected members of individual from the list of contacts and the option to forward the selected single message without a note, in accordance with the embodiments of the present invention.

FIG. 10 illustrates a graphical representation of the sender internet message folder showing forwarded message without a note in the individual message folder, in accordance with the embodiments of the present invention.

FIG. 11 illustrates a graphical representation of the sender internet message folder showing forwarded message without a note in the group message folder, in accordance with the embodiments of the present invention.

FIG. 12 illustrates a graphical representation of the sender internet messaging folder with a three-dot icon in this case used for forwarding multiple messages, in accordance with the embodiments of the present invention.

FIG. 13 illustrates a graphical representation of the sender internet messaging folder with the option to select the messages for forwarding multiple messages, in accordance with the embodiments of the present invention.

FIG. 14 illustrates a graphical representation of the sender internet messaging folder with the selected multiple messages for forwarding multiple messages, in accordance with the embodiments of the present invention.

FIG. 15 illustrates a graphical representation of the sender internet message folder with the share message count and the option to select the individual/multiple contacts/group/multiple groups/unknown contacts/unknown group from the list of contacts and the option to forward the selected messages with or without a note, in accordance with the embodiments of the present invention.

FIG. 16 illustrates a graphical representation of the sender internet message folder with the selected members of individual from the list of contacts and the option to forward the selected multiple messages, in accordance with the embodiments of the present invention.

FIG. 17 illustrates a graphical representation of the sender internet message folder with the selected group from the list of groups along with the selected members of individual from the list of contacts and the option to forward the selected multiple messages with a note, in accordance with the embodiments of the present invention.

FIG. 18 illustrates a graphical representation of the sender internet message folder showing the multiple forwarded messages, along with a note in the individual message folder, in accordance with the embodiments of the present invention.

FIG. 19 illustrates a graphical representation of the sender internet message folder showing the multiple forwarded messages, along with a note in the group message folder, in accordance with the embodiments of the present invention.

FIG. 20 illustrates a graphical representation of the sender internet message folder with the selected group from the list of groups along with the selected members of individual from the list of contacts and the option to forward the selected multiple messages without a note, in accordance with the embodiments of the present invention.

FIG. 21 illustrates a graphical representation of the sender internet message folder showing the multiple forwarded messages without a note in the individual message folder, in accordance with the embodiments of the present invention.

FIG. 22 illustrates a graphical representation of the sender internet message folder showing the multiple forwarded messages without a note in the group message folder, in accordance with the embodiments of the present invention

FIG. 23 illustrates a schematic workflow diagram of forwarding the message in a digital messaging application system, in accordance with the embodiments of the present invention.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure. Throughout the drawings, it should be noted that like reference numbers are used to depict the same or similar elements, features, and structures.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention relates to a novel and user-friendly mechanism of forwarding the messages within the application. This is a system and method for forwarding the messages (single message or multiple messages) to the individual/multiple individuals/group/multiple groups/unknown contacts/unknown groups with or without a forward note.

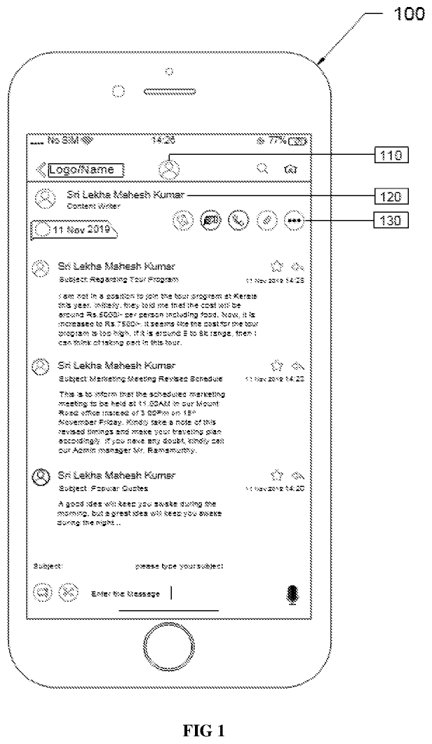

Referring to FIG. 1, an embodiment of the present invention illustrates a graphical representation of the sender internet message folder 100. The folder 100 includes (110) the sender profile icon, (120) the contact name in the contact message folder, (130) the three-dot icon. Clicking the three-dot icon helps to enable the checkbox for every message in the messaging folder for selection, in this case for forwarding single message with/without a note.

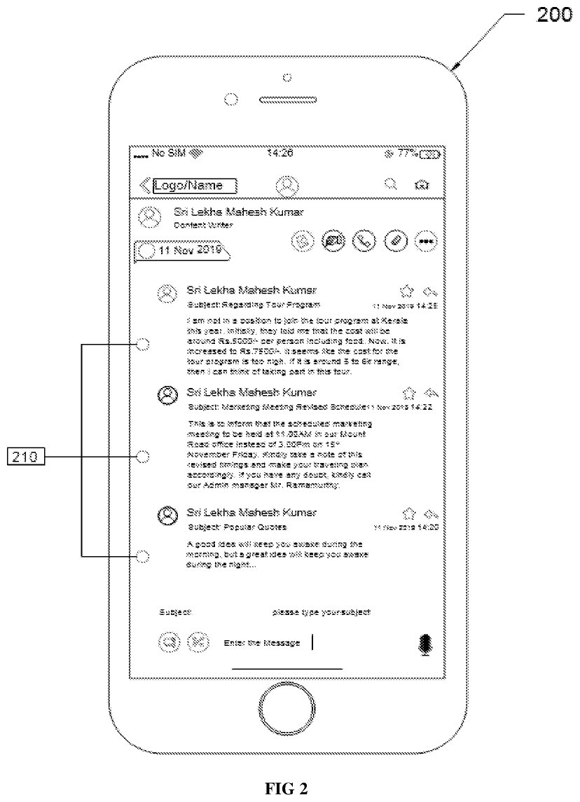

Referring to FIG. 2, an embodiment of the present invention illustrates a graphical representation of the sender internet message folder 200. The folder 200 includes enabled checkbox (210) for all the messages by clicking the three-dot icon for forwarding single message with/without a note.

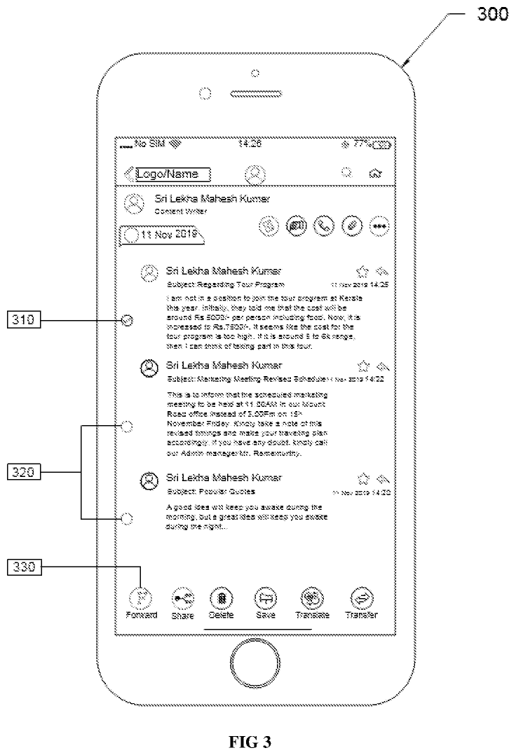

Referring to FIG. 3, an embodiment of the present invention illustrates a graphical representation of the sender internet message folder 300. The folder 300 includes the selected message (310) wherein the user has selected single message for forwarding, (320) the unselected messages, after selecting the forward option messages (330) is viewed along with other features like share, save, translate, transfer, copy, delete etc.

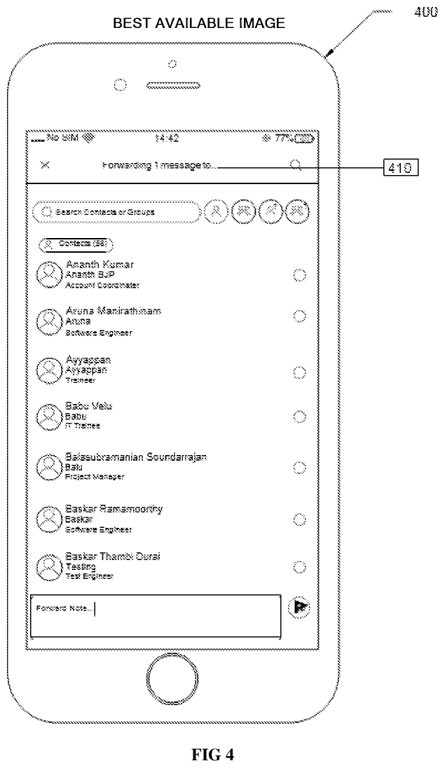

Referring to FIG. 4, an embodiment of the present invention illustrates a graphical representation of the sender internet message folder 400. The folder 400 includes (410) showing the count of the message to be forwarded.

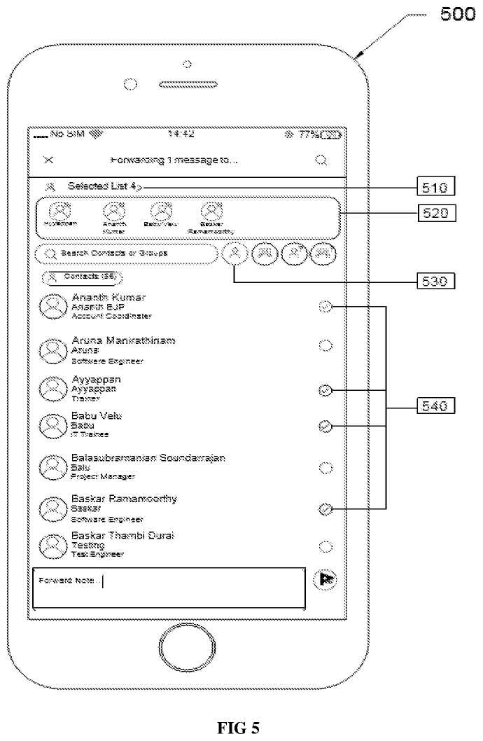

Referring to FIG. 5, an embodiment of the present invention illustrates a graphical representation of the sender internet message folder 500. The folder 500 includes (510) showing the count of the selected individual members from the contact list to which the message to be forwarded, (520) showing the selected individuals contacts in selected list, (530) showing the contact icon, (540) the selected individual contacts from the list of contacts.

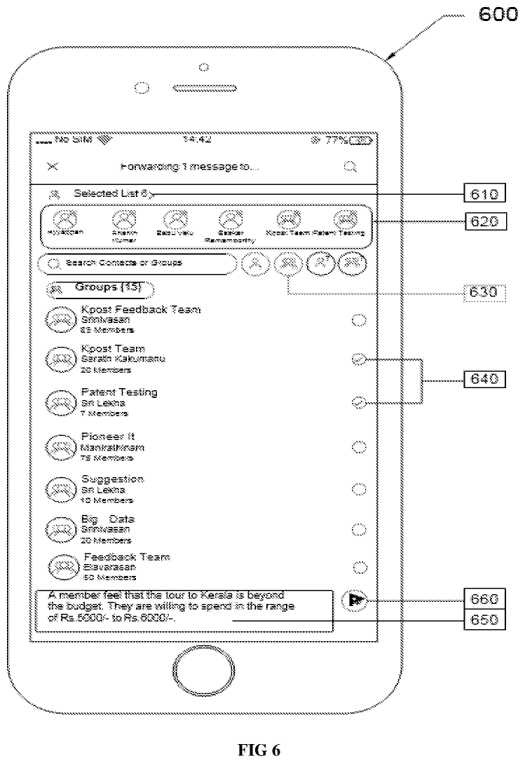

Referring to FIG. 6, an embodiment of the present invention illustrates a graphical representation of the sender internet message folder 600. The folder 600 includes (610) showing the count of selected individual members and groups from the contact list to whom the messages to be forwarded, (620) showing the selected individuals contacts and group contacts in the selected list, (630) showing the group contact icon, (640) the selected group of contacts from the group contact list, (650) the forward note option to send a note regarding the message to be forwarded, (660) the post icon to post the message with a forward note.

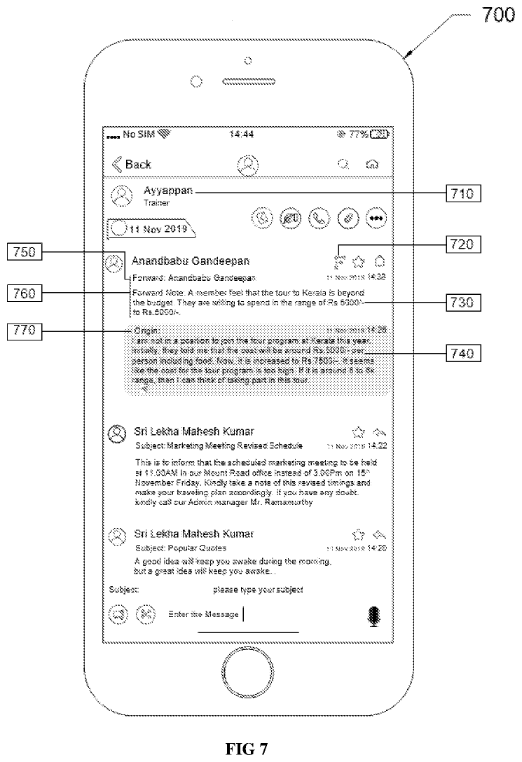

Referring to FIG. 7, an embodiment of the present invention illustrates a graphical representation of the sender internet message folder 700. The folder 700 includes (710) the recipient name (individual member) and profile picture, (720) the forward icon which indicates the message is a forwarded message, (730) the forward note, (740) the forward message, (750) the tag “Forward” indicates the sender name, (760) the tag “Forward Note” indicates the note, (770) the tag “origin” indicates that the message is the original message.

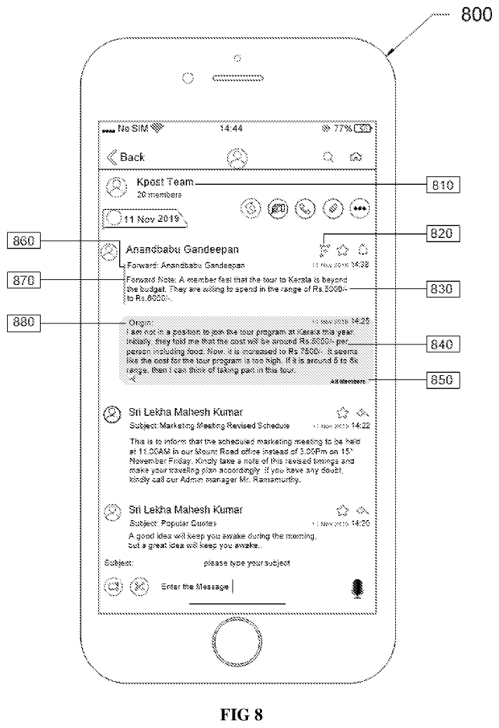

Referring to FIG. 8, an embodiment of the present invention illustrates a graphical representation of the sender internet message folder 800. The folder 800 includes (810) the recipient name (group name with member count) and profile picture, (820) the forward icon which indicates the message is a forwarded message, (830) the forward note, (840) the forward message, (850) shows that the message is forwarded to all members in the group, (860) the tag “Forward” indicates the sender name, (870) the tag “Forward Note” indicates the note, (880) the tag “origin” indicates that the message is the original message.

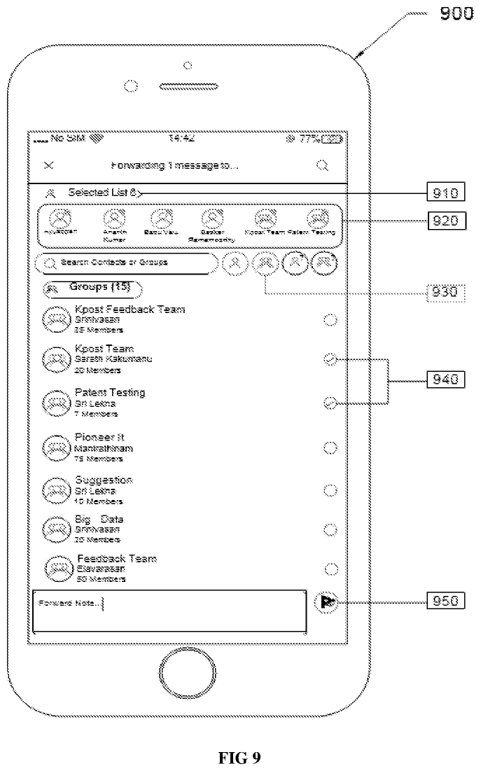

Referring to FIG. 9, an embodiment of the present invention illustrates a graphical representation of the sender internet message folder 900. The folder 900 includes (910) showing the count of selected individual members and groups from the contact list to whom the messages to be forwarded, (920) showing the selected individuals contacts and group contacts in the selected list, (930) showing the group contact icon, (940) the selected group of contacts from the group contact list, (950) the post icon to post the message without a note.

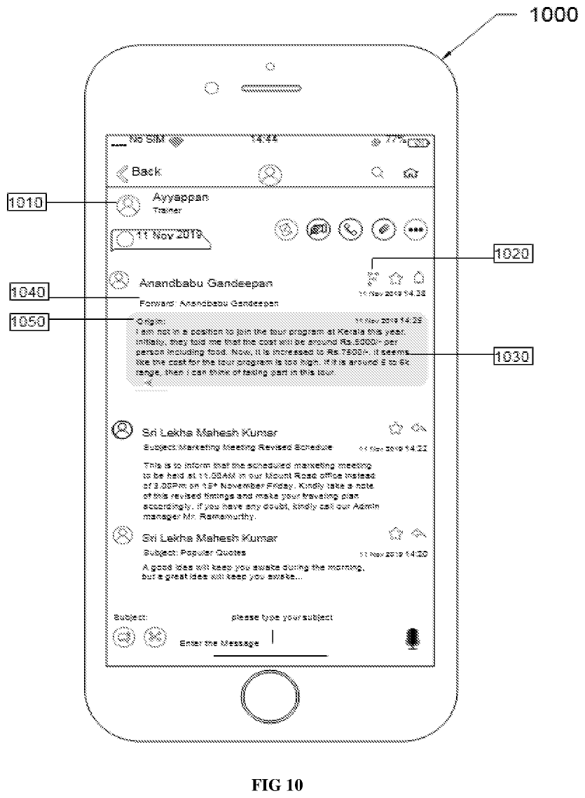

Referring to FIG. 10, an embodiment of the present invention illustrates a graphical representation of the sender internet message folder 1000. The folder 1000 includes (1010) the recipient name (individual member) and profile picture the (1020) the forward icon which indicates the message is a forward message with hidden source, (1030) the tag “origin” indicates that the message is the original message, (1040) the forward message without the note, (1050) the tag “Forward” indicates the sender name.

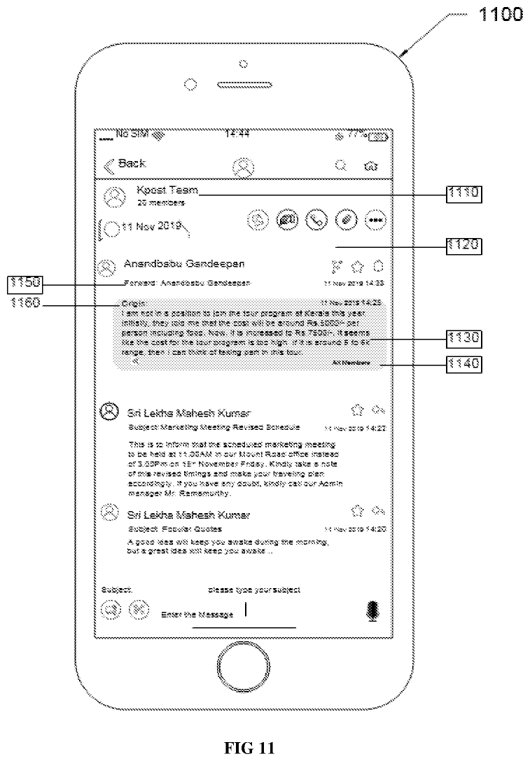

Referring to FIG. 11, an embodiment of the present invention illustrates a graphical representation of the sender internet message folder 1100. The folder 1100 includes (1110) (the recipient name (group name) and profile picture, (1120) the forward icon which indicates the message is a forward message with hidden source, (1130) the forward message without the note, (1040) shows that the message is forwarded to all members in the group, (1150) the tag “Forward” indicates the sender name, (1160) the tag “origin” indicates that the message is the original message.

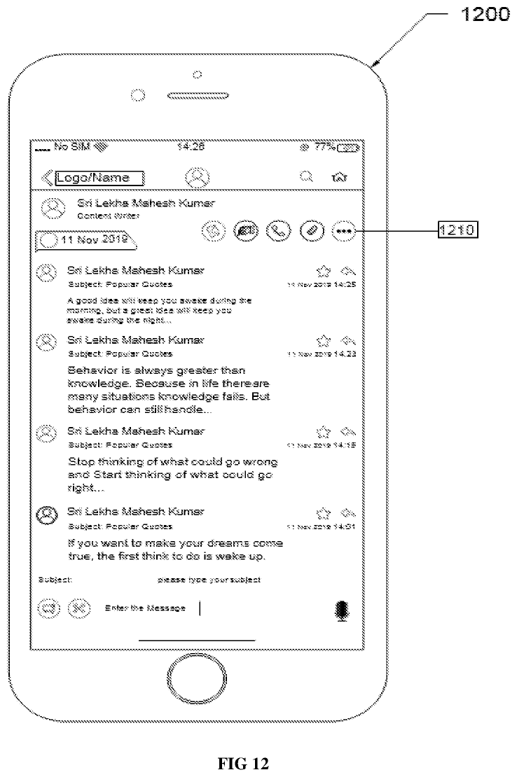

Referring to FIG. 12, an embodiment of the present invention illustrates a graphical representation of the sender internet message folder 1200. The folder 1200 includes the three-dot icon (1210). Clicking the three-dot icon helps to enable the checkbox for every message in the messaging folder for selection, in this case for forwarding multiple messages with/without a note.

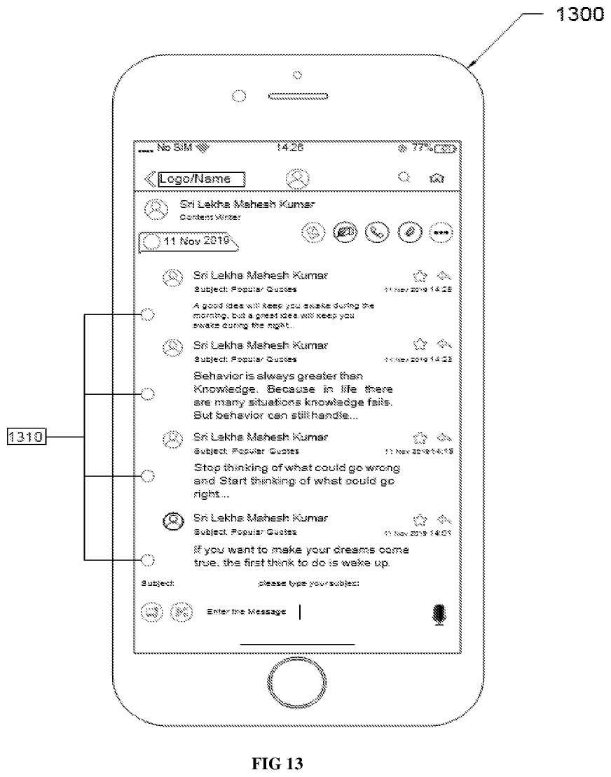

Referring to FIG. 13, an embodiment of the present invention illustrates a graphical representation of the sender internet message folder 1300. The folder 1300 includes (1310) the enabled checkbox for all the messages by clicking the three-dot icon for forwarding multiple messages with/without a note.

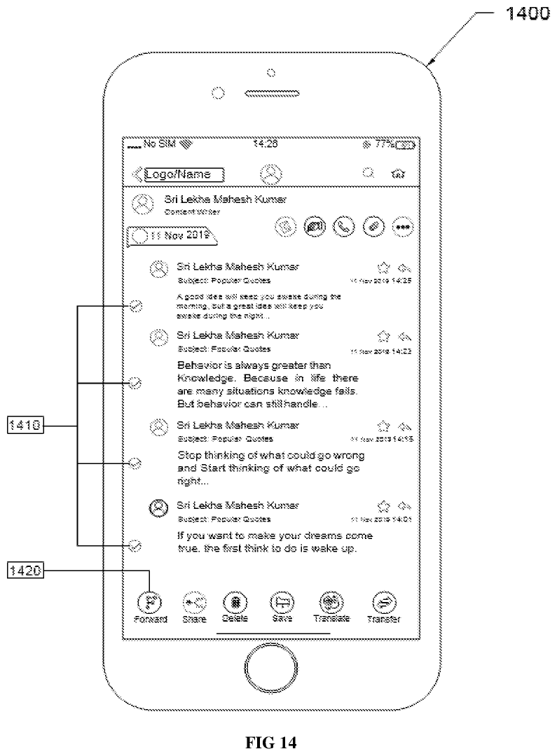

Referring to FIG. 14, an embodiment of the present invention illustrates a graphical representation of the sender internet message folder 1400. The folder 1400 includes the selected messages (1410) wherein the user has selected multiple messages for forwarding, after selecting the multiple message (1420) the forward option is viewed along with other features like share, save, translate, transfer, copy, delete etc.

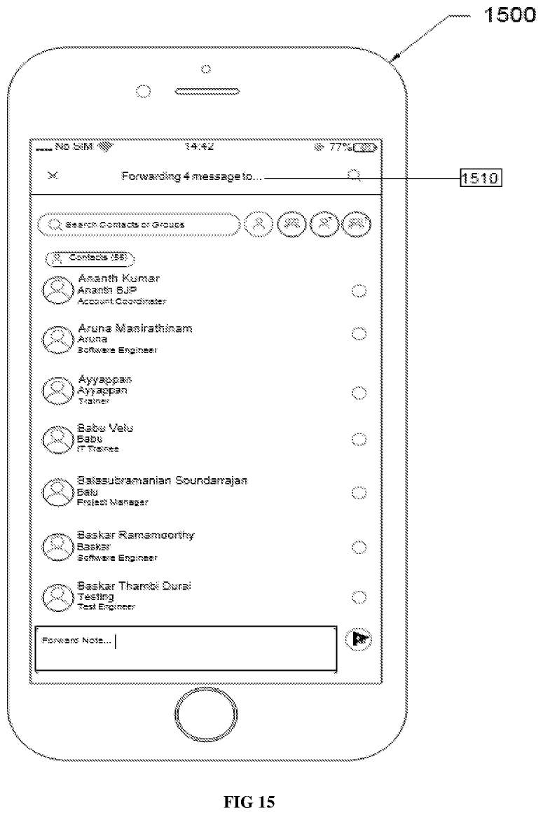

Referring to FIG. 15, an embodiment of the present invention illustrates a graphical representation of the sender internet message folder 1500. The folder 1500 includes (1510) showing the count of the messages to be forwarded with/without a note.

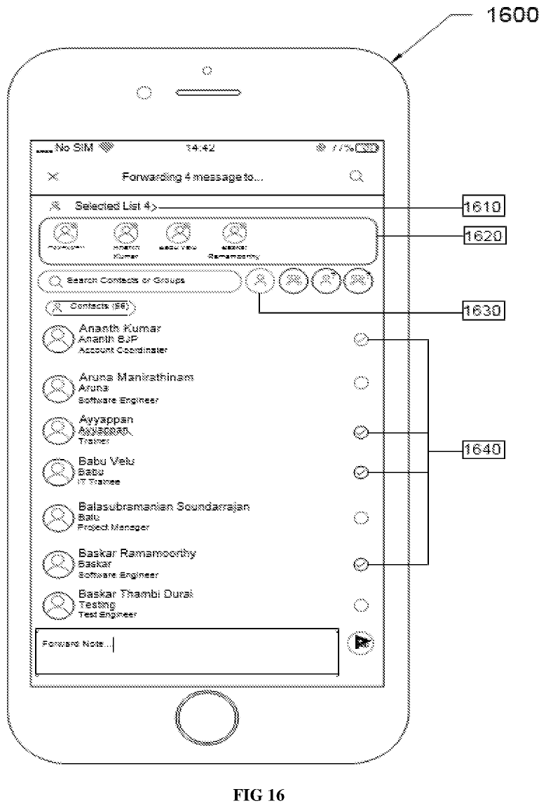

Referring to FIG. 16, an embodiment of the present invention illustrates a graphical representation of the sender internet message folder 1600. The folder 1600 includes (1610) showing the count of the selected members of individual from the contact list to whom the message to be forwarded, (1620) showing the selected members of individuals in the selected list, (1630) showing the contact icon, (1640) the selected individual contacts.

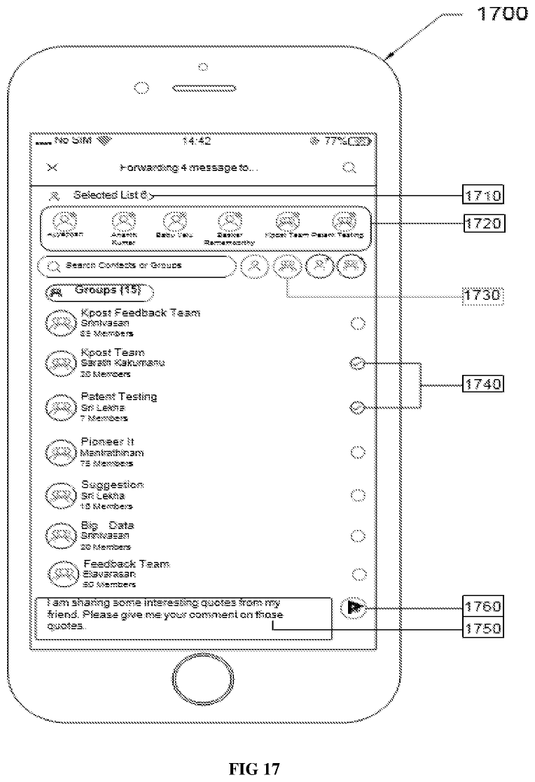

Referring to FIG. 17, an embodiment of the present invention illustrates a graphical representation of the sender internet message folder 1700. The folder 1700 includes (1710) showing the count of selected members of individual and selected groups from the contact list to whom the messages to be forwarded with a note, (1720) showing the selected individuals contacts and group contacts, (1730) showing the group contact icon, (1740) the selected group contacts, (1750) the forward note option to send a note regarding the message to be forwarded, (1760) the post icon to post the message with a forward note.

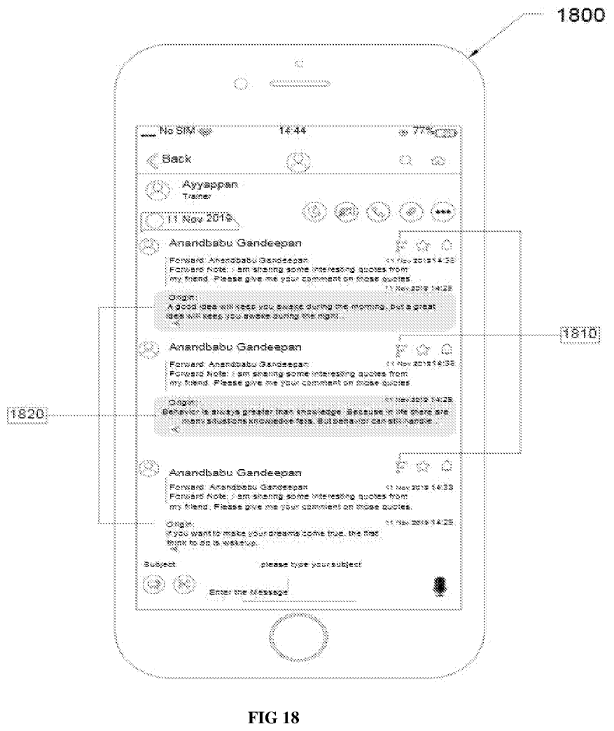

Referring to FIG. 18, an embodiment of the present invention illustrates a graphical representation of the sender internet message folder 1800. The folder 1800 includes (1810) the forward icon which indicates the messages are forwarded messages, (1820) the forward message with a note.

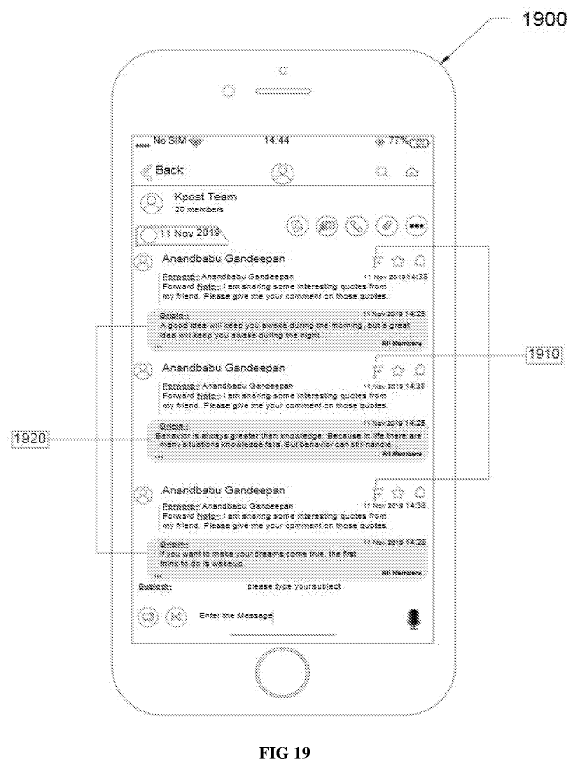

Referring to FIG. 19, an embodiment of the present invention illustrates a graphical representation of the sender internet message folder 1900. The folder 1900 includes (1910) the forward icon which indicates the messages are forwarded messages, (1920) shows that the multiple messages are forwarded to all members in the group with a note.

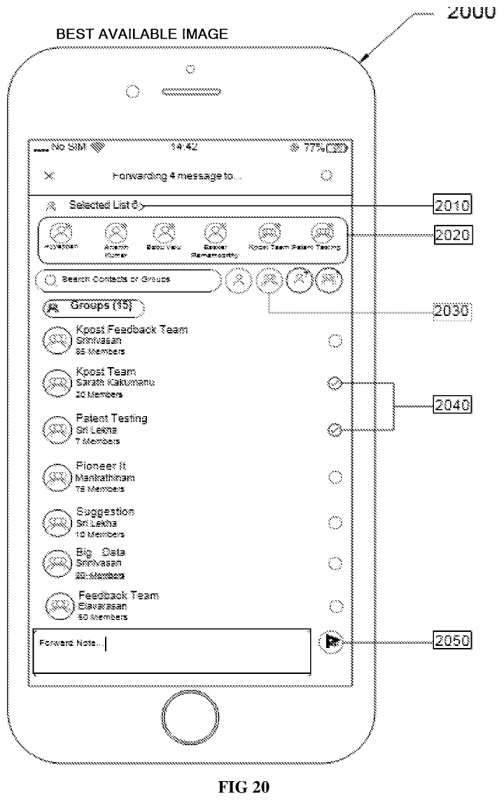

Referring to FIG. 20, an embodiment of the present invention illustrates a graphical representation of the sender internet message folder 2000. The folder 2000 includes (2010) showing the count of selected members of individual and selected groups from the contact list to whom the messages to be forwarded with a note, (2020) showing the selected individuals contacts and group contacts, (2030) showing the group contact icon, (2040) the selected group contacts, (2050) the post icon to post the message without a forward note.

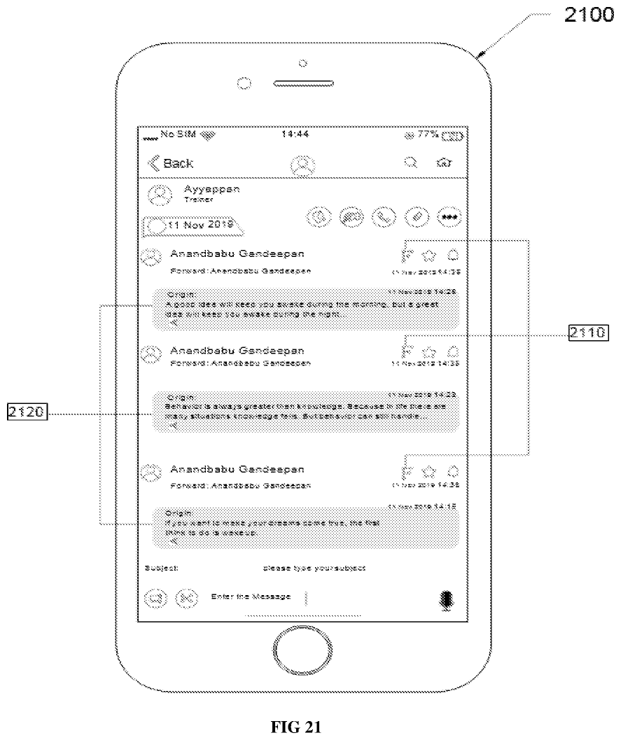

Referring to FIG. 21, an embodiment of the present invention illustrates a graphical representation of the sender internet message folder 2100. The folder 2100 includes (2110) the forward icon which indicates the messages are forwarded messages, (2120) the forward message without a forward note, in accordance with the disclosed embodiments.

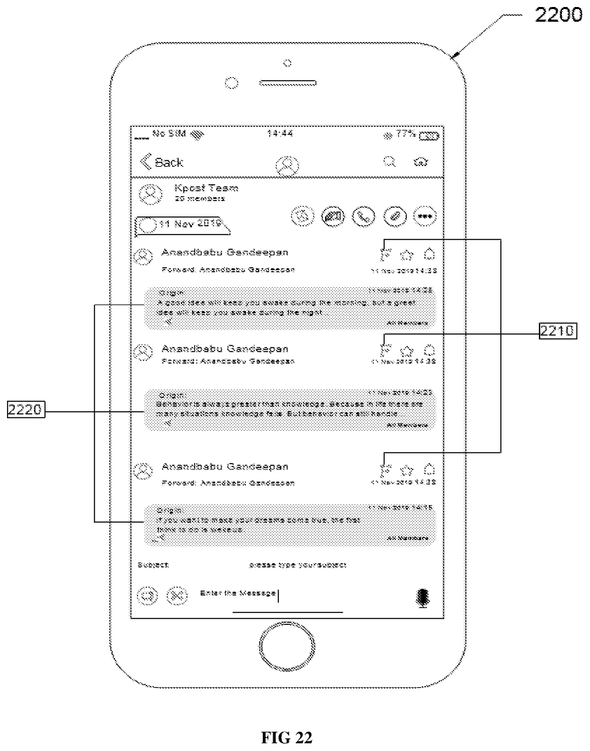

Referring to FIG. 22, an embodiment of the present invention illustrates a graphical representation of the sender internet message folder 2200. The folder 2200 includes (2210) the forward icon which indicates the messages are forwarded messages, (2220) multiple messages are forwarded to all members in the group message without a forward note, in accordance with the disclosed embodiments.

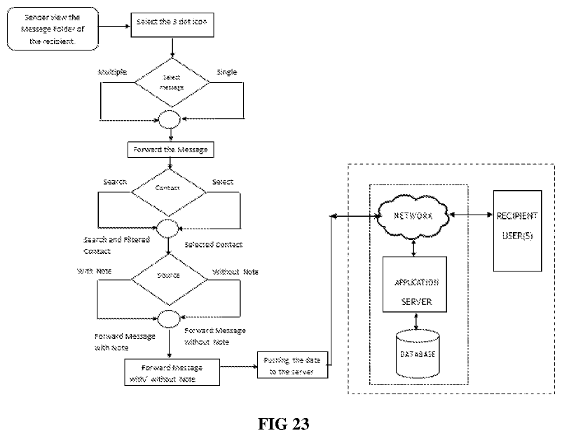

Referring to FIG. 23, according to an embodiment, a method for sharing at least one message or more than one message from the sender side to the receiver side has been provided and shown.

The sender is an individual/group member. The receiver is an individual/multiple individual/group/multiple groups. The method comprises selecting a single message or multiple messages by the sender from a sender device, searching and selecting of the receiver (individual/multiple individual/group/multiple groups) by the sender and forwarding the selected single message or multiple messages, and forwarding the selected single message or more than one message from the sender device to the receiver device (mobile phones, laptop computers, desktop computers, digital tablets, etc) of the selected receiver (individual/multiple individual/group/multiple groups). The sender device includes but not limited to mobile phones, laptop computers, desktop computers, digital tablets etc.

The interface of the sender device provides option for forwarding a selected single message or more than one message by adding note or without note. According to the option selected by the sender (adding a note or without adding a note), the receiver receives the forward message, by the receiver device of the selected receiver (individual/multiple individual/group/multiple groups). In an embodiment, the sender is an individual or a user of a group of users.

According to another embodiment, a system for forwarding a message is provided. The system comprises a sender device of a sender configured to send and receive the forward messages using an interface, a receiver device of a receiver configured to send and receive forward messages using an interface, and a server unit communicably coupled to the sender device and the receiver device (the sender and receiver device includes mobile phones, laptop computers, desktop computers, digital tablets, etc). The server unit is configured to receive, process and forward the messages to and from the sender device and the receiver device. The sender device is configured to select, one message/multiple messages, search and select, at least one-second user or a plurality of users or a group of users or a plurality of group of users, and forward the selected message using an interface of the sender device. The interface of the sender device comprises, selecting single message or multiple message by the sender, for forwarding the selected message by adding with or without note to a receiver device of a second user or a plurality of users or a group of users or a plurality of group of users, according to the forward option done by the first user (sender), wherein the first receiver device is configured to receive the forward message from the first sender device.

According to another embodiment, a computer program product comprising instructions is provided which, when executed by at least one processor, causes the processor to carry out the instructions for selecting, at least one message, by the first user from a sender device, searching and selecting, at least one second user or a plurality of users or a group of users or a plurality of group of users, by the first user (sender) from the sender device, and forwarding, at least one selected message by the first user from the sender device by adding a note or without note, using an interface of the sender device. The interface of the sender device comprises providing, to the first user an option for selecting the single message or multiple messages, forwarding the selected single or multiple messages with note or without note from the sender device to the receiver device of the selected one-second user or a plurality of users or a group of users or a plurality of group of users, according to the option selected by the first user and receiving the forward message by the receiver device of the selected at least one-second user or a plurality of users or a group of users or a plurality of group of users, according to the option selected by the first user.

Another embodiment teaches a non-transitory computer-readable storage medium storing one or more programs for execution by the one or more processors of a system for forwarding a message, the one or more programs including instructions for selecting, one message or more than one message, by the first user from a sender device, searching and selecting, one-second user or a plurality of users or a group of users or a plurality of group of users by the first user from the sender device and forwarding one selected message or more than one message by the sender from the sender device, using an interface of the sender device, wherein the interface of the sender device comprises providing, to the first user, an option to add note for forwarding one selected message or more than one message, to a first receiver device of a one-second user or a plurality of users or a group of users or a plurality of group of users. Forwarding the message from the sender device to the receiver device of the selected at least one-second user or a plurality of users or a group of users or a plurality of group of users, with the option of adding the note or without note. The forward message is received by the first receiver device of the selected one-second user or a plurality of users or a group of users or a plurality of group of users, according to the option selected by the first user.

In the aforementioned embodiments, selecting at least one message, by the sender comprises selecting a message or a plurality of messages received by the first user from other users in the sender device, the option of adding note for forwarding the message comprises forwarding the message from the interface of the sender device, by adding note to the selected one message or more than one message or option for forwarding the message, from the interface of the sender device, of selected one message or more than one message without a note, forwarding the message comprises adding a subject note, by the first user, with the at least one message or more than one message selected by the first user for forwarding to the selected one-second user or a plurality of users or a group of users or a plurality of group of users.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A method for forwarding at least one message from a first user (sender) to a second user (receiver) or multiple users or a group of users or multiple group of users, the method comprising:
selecting, at least one message or more than one message, by the first user from a first sender device;
searching and selecting, at least one second user (receiver) or multiple users or a group of users or multiple group of users, by the first user from the first sender device;
forwarding, the at least one selected message or more than one message by the first user (sender) from the first-sender device, using an interface of the first sender device;
wherein the interface of the first sender device comprises:
providing, to the first user, an option for forwarding at least one selected message or more than one message;
selecting the at least one message or more than one message, by the first user, and forwarding to a first receiver device of a selected second user (receiver) or multiple users or a group of users or multiple group of users;
forwarding the message from the first sender device to the first receiver device of the selected at least one second user (receiver) or multiple users or a group of users or multiple group of users, according to the option selected by the first user (with or without note); and
receiving the forward message, by the first receiver device of the selected at least one second user (receiver) or multiple users or a group of users or multiple group of users, according to the option selected by the first user,
wherein the first user is an individual or a user of the group of users.

2. The method as claimed in claim 1, wherein the selecting, at least one message, by the first user comprises selecting a message or a plurality of messages received by the first user from other users, in the first sender device.

3. The method as claimed in claim 1 or claim 2, wherein the forwarding the message comprises forwarding the message, from the interface of the first sender device, by adding a note to the at least one selected message or more than one message.

4. The method as claimed in any one of claims 1-3, further comprising adding a subject note, by the first user, with the at least one message selected by the first user for forwarding to the selected at least one second user or multiple users or a group of users or multiple group of users.

5. A system for forwarding a message, the system comprises:
a first sender device of a first user configured to send and receive the forward messages using an interface;
a first receiver device of a second user configured to send and receive forward messages using an interface;
a server unit communicably coupled to the first sender device and the first receiver device, the server unit being configured to receive, process and forward the messages to and from the first sender device and the first receiver device, and
wherein the first user and second user are individual or a user of a group of users,
wherein the first sender device is configured to:
select, at least one message;
search and select, at least one second user (receiver) or multiple users or a group of users or multiple group of users;
forward, the at least one selected message using an interface of the first sender device wherein the interface of the first sender device comprises:
selecting an option for forwarding the at least one selected message, by the first user, from the plurality of options for forwarding the at least one selected message to a first receiver device of a second user (receiver) or multiple users or a group of users or multiple group of users; and
forwarding the message from the first sender device to the first receiver device of the selected at least one second user or multiple users or a group of users or multiple group of users,
wherein the first receiver device is configured to:
receive the forward message from the first sender device.

6. The system as claimed in claim 5, wherein the first sender device is configured to select a message or a plurality of messages received by the first user from other users.

7. The system as claimed in claim 5 or claim 6, wherein the first sender device is configured to:
forward the message, by adding the subject note to the at least one selected message or more than one message to the selected at least one second user (receiver) or multiple users or a group of users or multiple group of users.
forward the message, without adding the subject note to the at least one selected message or more than one message to the selected at least one second user (receiver) or multiple users or a group of users or multiple group of users.

8. The system as claimed in claim 5, wherein the server unit is located on a cloud platform or on premise for receiving, processing and sending forward messages to and from the first and the second terminal devices.

9. A computer program product comprising instructions which, when executed by at least one processor, causes the processor to carry out the instructions for:
selecting, at least one message, by the first user from a first sender device;
searching and selecting at least one second user or multiple users or a selected group of users or multiple group of users, by the first user from the first sender device;
forwarding, at least one selected message by the first user from the first sender device, using an interface of the first sender device, wherein the interface of the first sender device comprises:
providing, to the first user, a plurality of options for forwarding the at least one selected message;
selecting an option for forwarding the at least one selected message, by the first user, from the plurality of options for forwarding the at least one selected message to a first receiver device of a second user (receiver) or a group of users;
forwarding the message from the first sender device to the first receiver device of the selected at least one second user or multiple users or a selected group of users or multiple group of users, according to the option selected by the first user; and
receiving the message, by the first receiver device of the selected at least one second user (receiver) or multiple users or a group of users or multiple group of users, according to the option selected by the first user,
wherein the first user is an individual or a user of the group of users,
wherein the selecting, at least one message, by the first user comprises selecting a message or a plurality of messages received by the first user from other users, in the first sender device,
forwarding the message comprises adding a subject note, by the first user, with the at least one message or more than one message selected by the first user for forwarding to the selected at least one second user or multiple users or a selected group of users or multiple group of users.

10. A non-transitory computer readable storage medium storing one or more programs for execution by the one or more processors of a system for forwarding a message, the one or more programs including instructions for:
selecting, at least one message, by the first user from a first sender device;
searching and selecting, at least one second user (receiver) or multiple users or a group of users or multiple group of users, by the first user from the first sender device;
forwarding, the at least one selected message or more than one message by the first user from the first sender device, using an interface of the first sender device, wherein the interface of the first sender device comprises:
providing, to the first user, an option for forwarding the at least one selected message;
selecting the at least one message or more than one message, by the first user, and forwarding to a first receiver device of a second user (receiver) or multiple users or a group of users or multiple group of users;
forwarding the message from the first sender device to the first receiver device of the selected at least one second user or multiple users or a selected group of users or multiple group of users, according to the option selected by the first user (with or without note); and
receiving the forward message, by the first receiver device of the selected at least one second user or multiple users or a selected group of users or multiple group of users, according to the option selected by the first user,
wherein the first user is an individual or a user of the group of users,
wherein the selecting, at least one message, by the first user comprises selecting a message or a plurality of messages received by the first user from other users, in the first sender device,
forwarding the message further comprises adding a subject note, by the first user, with the at least one message or more than one message selected by the first user forwarding to the selected at least one second user or multiple users or a selected group of users or multiple group of users.
